(19) United States
(12) Patent Application Publication
(10) Pub. No.: US 2021/0261797 A1
(43) Pub. Date: Aug. 26, 2021

(54) LIQUID COMPOSITIONS COMPRISING PARTICLES OF A CONDUCTIVE POLYMER AND AN ORGANIC SOLVENT FORMING AN AZEOTROPE WITH WATER

(71) Applicant: HERAEUS DEUTSCHLAND GMBH & CO. KG, Hanau (DE)

(72) Inventors: Arnulf Scheel, Köln (DE); Udo Guntermann, Krefeld (DE); Wilfried Lövenich, Bergisch Gladbach (DE); Armin Sautter, Düsseldorf (DE)

(21) Appl. No.: 17/256,196

(22) PCT Filed: Jun. 26, 2019
(86) PCT No.: PCT/EP2019/067097

§ 371 Date: Dec. 26, 2020

(30) Foreign Application Priority Data
Jun. 28, 2018 (EP) 18180537.5

(51) Int. Cl. C09D 5/24; C09D 7/20; C09D 125/18; C09D 7/63; C09D 11/52; C09D 11/106; C09D 11/033; C09D 11/037; C09D 11/322; H01B 1/12

(52) U.S. Cl. CPC C09D 5/24; C09D 7/20; C09D 125/18; C09D 7/63; H01B 1/127; C09D 11/106; C09D 11/033; C09D 11/037; C09D 11/322; C09D 11/52

(57) ABSTRACT

A liquid composition. The liquid composition comprises particles comprising a complex of a polythiophene and a polyanion; and a liquid phase comprising water and at least one organic solvent having a boiling point, determined at a pressure of 1013 mbar, in the range from 110 to 250° C. and a solubility in water, determined at 25° C., of at least 10 wt.-%. The liquid phase is an azeotrope or is capable of forming an azeotrope. Also disclosed is a process for the preparation of a layered body, the layered body obtainable by such a process, and the use of a liquid composition.

### CROSS REFERENCE TO RELATED APPLICATIONS

This application is a U.S. National Phase filing of International Patent Application No. PCT/EP2019/067097 filed on Jun. 26, 2019, which claims the priority of European Patent Application No. 18180537.5 filed on Jun. 28, 2018.

### TECHNICAL FIELD

The present invention relates to a liquid composition which comprises particles comprising a complex of a polythiophene and a polyanion, to a process for the preparation of a layered body, to the layered body obtainable by such a process and to the use of a liquid composition.

### BACKGROUND OF THE DISCLOSURE

Conductive polymers are increasingly gaining economic importance, since polymers have advantages over metals with respect to processability, weight and targeted adjustment of properties by chemical modification. Examples of known π-conjugated polymers are polypyrroles, polythiophenes, polyanilines, polyacetylenes, polyphenylenes and poly(p-phenylene-vinylenes). Layers of conductive polymers are employed in diverse industrial uses, e.g., as polymeric counter-electrodes in capacitors or for through-plating of electronic circuit boards. The preparation of conductive polymers is carried out chemically or electrochemically by oxidation from monomeric precursors, such as, e.g., optionally substituted thiophenes, pyrroles and anilines and the particular optionally oligomeric derivatives thereof. In particular, chemically oxidative polymerization is widely used, since it is easy to realize industrially in a liquid medium or on diverse substrates.

A particularly important polythiophene which is used industrially is poly(3,4-ethylenedioxy-thiophene) (PEDOT or PEDT), which is described, for example, in EP 0 339 340 A2 and is prepared by chemical polymerization of 3,4-ethylenedioxythiophene (EDOT or EDT), and which has very high conductivities in its oxidized form. An overview of numerous poly(3,4-alkylenedioxythiophene) derivatives, in particular poly(3,4-ethylenedioxythiophene) derivatives, and their monomer units, syntheses and uses is given by A. Elschner, S. Kirchmeyer, W. Lovenich, U. Merker, & K. Reuter, “PEDOT Principles and Applications of an Intrinsically Conductive Polymer,” CRC Press (2011). Often 3,4-ethylene-dioxythiophene is polymerized in water in the presence of polyanions such as polystyrene sulfonate (PSS), whereby aqueous compositions are obtained containing a complex of the cationic polythiophene and the polyanion (often referred to as “PEDOT/PSS”). Such a process is, for example, disclosed in EP 0 440 957 A2. Due to the polyelectrolyte properties of PEDOT as a polycation and PSS as a polyanion, these compositions are not a true solution, but rather a dispersion. The extent to which polymers or parts of the polymers are dissolved or dispersed in this context depends on the weight ratio of the polycation and the polyanion, on the charge density of the polymers, on the salt concentration of the environment and on the nature of the surrounding medium (V. Kabanov, Russian Chemical Reviews 74, 3-20 (2005)).

PEDOT/PSS-dispersions have acquired particular industrial importance. Transparent, conductive films which have found a large number of uses, e.g., as antistatic coatings or as conductive layers in electronic components, for example as a hole injection layer in organic light-emitting diodes (OLED), as an intermediate layer in organic photovoltaic elements (OPV elements) or in organic photo detectors (OPD) or as an electromagnetic interference (EMI) shielding material. They are also commonly used for the formation of conductive polymers layers, in particular solid electrolyte layers or polymeric outer layers, and in the production of solid electrolyte capacitors.

However, aqueous PEDOT/PSS-dispersions known from the prior art often dry too fast upon contact with the air, which leads to a clogging of the devices used to apply these dispersions onto substrates, such as slot-die-coaters, ink-jet printers or spraying nozzles. In order to reduce the drying speed of aqueous PEDOT/PSS-dispersions, high-boiling solvents such as ethylene glycol and DMSO (i.e., solvents having a boiling point that is higher than the boiling point of water) have been added. Such an approach is, for example, disclosed in EP 0 686 662 A2. Adding such high-boiling solvents, however, also leads to a significant reduction of the sheet resistance of the resulting conductive polymer films, which is not desired when using conductive polymer layers as antistatic coatings, as an electromagnetic radiation shield or as a hole-transport layer in an organic light emitting diode (OLED) or in an organic photovoltaic (OPV) element or in an organic photo detector (OPD).

The present invention was based on the object of overcoming the disadvantages resulting from the prior art in connection with liquid compositions comprising polythiophenes, in particular with PEDOT/PSS-dispersions.

In particular, the present invention was based on the object of providing a liquid composition comprising polythiophenes that can be used for the formation of conductive layers with sufficiently high sheet resistance that allows the use of the compositions for the formation of an antistatic coating or an electromagnetic radiation shield or for the preparation of a hole-transport layer in an organic light emitting diode (OLED) or in an organic photovoltaic (OPV) element or in an organic photo detector (OPD), wherein the liquid composition does not lead to a clogging of devices used to apply these dispersions onto substrates, such as ink-jet printers or spraying nozzles.

### SUMMARY OF THE INVENTION

To achieve these and other objects, and in view of its purposes, the present disclosure can be summarized in at least the following thirty-seven enumerated embodiments.

### EMBODIMENTS

|1| A liquid composition comprising
i) particles comprising a complex of a polythiophene and a polyanion; and
ii) a liquid phase, wherein the liquid phase comprises
iia) water and
iib) at least one organic solvent having
   a boiling point, determined at a pressure of 1013 mbar, in the range from 110 to 250° C., preferably in the range from 120 to 225° C. and most preferably in the range from 130 to 200° C., and
   a solubility in water, determined at 25° C., of at least 10 wt.-%, preferably at least 25 wt.-%, more preferably at least 50 wt.-% and most preferably at least 90 wt.-%;
wherein the liquid phase is an azeotrope or is capable of forming an azeotrope.

|2| The liquid composition according to embodiment |1|, wherein the liquid composition is a dispersion in which particles i) are dispersed in the liquid phase ii).

|3| The liquid composition according to embodiment |1| or |2|, wherein the polythiophene is poly(3,4-ethylenedioxythiophene) (PEDOT).

|4| The liquid composition according to any one of embodiments |1| to |3|, wherein the polyanion is an anion of polystyrene sulfonic acid (PSS).

|5| The liquid composition according to any one of embodiments |1| to |4|, wherein the complex of a polythiophene and a polyanion is a PEDOT/PSS-complex.

|6| The liquid composition according to any one of embodiments |1| to |5|, wherein the weight average diameter (d₅₀) of particles i) is in the range from 10 nm to 2,000 nm, more preferably in the range from 20 nm to 500 nm, and most preferably in the range from 25 nm to 50 nm.

|7| The liquid composition according to any one of embodiments |1| to |6|, wherein the organic solvent iib) is an alcohol, preferably ethyl glycol, butyl glycol or diacetone alcohol, an ether, preferably diethylene glycol dimethyl ether (Diglyme), or a mixture thereof.

|8| The liquid composition according to embodiment |7|, wherein the organic solvent iib) is an alcohol.

|9| The liquid composition according to embodiment |8|, wherein the alcohol is selected from the group consisting of ethyl glycol, butyl glycol, diacetone alcohol or a mixture thereof.

|10| The liquid composition according to embodiment |9|, wherein the alcohol is diacetone alcohol.

|11| The liquid composition according to embodiment |9|, wherein the alcohol is ethyl glycol.

|12| The liquid composition according to embodiment |9|, wherein the alcohol is butyl glycol.

|13| The liquid composition according to any one of embodiments |1| to |12|, wherein the liquid composition further comprises
iii) at least one additive selected from the group consisting of an UV-stabilizer, a surface-active substance, a low-boiling solvent, a pH-regulator, a crosslinker, a rheology modifier or a combination of at least two of these additives.

|14| The liquid composition according to embodiment |13|, wherein the low-boiling solvent is ethanol.

|15| The liquid composition according to embodiment |13| or |14|, wherein the liquid composition comprises a low-boiling solvent, preferably ethanol, in an amount of 10 to 90 wt.-%, more preferably 20 to 85 wt.-% and most preferably 30 to 80 wt.-%, in each case based on the total weight of the liquid composition.

|16| The liquid composition according to any one of embodiments |13| to |15|, wherein the UV-stabilizer is gallic acid, a derivative of gallic acid or a mixture thereof.

|17| The liquid composition according to embodiment |16|, wherein the derivative of gallic acid is an ester of gallic acid and a sugar.

|18| The liquid composition according to embodiment |17|, wherein the derivative of gallic acid is a gallotannine.

|19| The liquid composition according to embodiment |18|, wherein the gallotannine is tannic acid.

|20| The liquid composition according to embodiment |16|, wherein the derivative of gallic acid is an alkyl ester, alkenyl ester, cycloalkyl ester, cycloalkenyl ester or aryl ester of gallic acid.

|21| The liquid composition according to embodiment |20|, wherein the ester has 1 to 15 C-atoms, preferably 1 to 6 C-atoms in the alkyl group, the alkenyl group, the cycloalkyl group, the cycloalkenyl group or the aryl group of the ester.

|22| The liquid composition according to embodiment |21|, wherein the ester is methyl gallate, ethyl gallate, propyl gallate or a mixture of at least two of these esters.

|23| The liquid composition according to any one of embodiments |13| to |22|, wherein the crosslinker is a tetraalkyl orthosilicate.

|24| The liquid composition according to embodiment |23|, wherein the tetraalkyl orthosilicate is selected from the group consisting of tetramethyl orthosilicate, tetraethyl orthosilicate, tetrapropyl orthosilicate, tetrabutyl orthosilicate, tetrapentyl orthosilicate, orthosilicate, an at least partially hydrolysed product of these orthosiliscates and a mixture of at least two of these orthosiliscates.

|25| The liquid composition according to embodiment |24|, wherein the tetraalkyl orthosilicate is tetraethyl orthosilicate (TEOS).

|26| The liquid composition according to any one of embodiments |1| to |25|, wherein the liquid composition comprises the complex i) of a polythiophene and a polyanion, preferably PEDOT/PSS, in an amount of 0.001 to 2.5 wt.-%, more preferably 0.005 to 1.0 wt.-% and most preferably 0.01 to 0.5 wt.-%, in each case based on the total weight of the liquid composition.

|27| The liquid composition according to any one of embodiments |1| to |26|, wherein the liquid composition comprises water iia) in an amount in the range from 10 to 98 wt.-%, preferably in the range from 20 to 97 wt. %, more preferably in the range from 30 to 96 wt.-% and even more preferably in the range from 40 to 95 wt.-%, in each case based on the total weight of the liquid composition.

|28| The liquid composition according to any one of embodiments |1| to |27|, wherein the liquid composition comprises the at least one organic solvent iib) in an amount of less than 10 wt.-%, preferably less than 8.5 wt.-% and more preferably less than 7 wt.-%, in each case based on the total weight of the liquid composition. In the case of two or more organic solvents iib), these amounts define the total amount of organic solvents iib).

|29| The liquid composition according to any one of embodiments |1| to |28|, wherein a dried layer prepared with the liquid composition has a sheet resistance of at least 1×10⁶ Ω/sq, preferably of at least 5×10⁶ Ω/sq and more preferably of at least 1×10⁷ Ω/sq.

|30| The liquid composition according to any one of embodiments |1| to |29|, wherein a dried layer prepared with the liquid composition has an internal transmission of at least 98%, preferably of at least 98.5%, more preferably of at least 99% and most preferably of at least 99.5%.

|31| The liquid composition according to any one of embodiments |1| to |30|, wherein a dried layer prepared with the liquid composition has a pencil hardness of at least 6H, preferably of at least 7H, more preferably of at least 8H and most preferably of at least 9H.

|32| The liquid composition according to any one of embodiments |1| to |31|, wherein the pH of the liquid composition is not less than 2.5, more preferably the pH is in the range from 2.5 to 6, even more preferably in the range from 2.5 to 5 and most preferably in the range from 2.5 to 4, wherein the pH is determined at a temperature of 25° C.

|33| A process for the preparation of a layered body, comprising the process steps:
A) the provision of a substrate;
B) the application of the liquid composition according to one of embodiments |1| to |32| onto this substrate; and
C) the at least partial removal of the liquid phase ii) from the liquid composition to obtain a layered body comprising an electrically conductive layer coated onto the substrate.

|34| The process according to embodiment |33|, wherein application of the liquid composition in process step B) is performed by slot die coating, spraying or ink-jet printing.

|35| A layered body, obtainable by the process according to embodiment |34|.

|36| The layered body according to embodiment |35|, wherein the conductive layer of the layered body is characterized by at least one of the following properties (α1) to (α3), preferably by all of these properties:
(α1) a sheet resistance of at least 1×10⁶ Ω/sq, preferably of at least 5×10⁶ Ω/sq and more preferably of at least 1×10⁷ Ω/sq;
(α2) an internal transmission of at least 98%, preferably of at least 98.5%, more preferably of at least 99% and most preferably of at least 99.5%; and
(α3) a pencil hardness of at least 6H, preferably of at least 7H, more preferably of at least 8H and most preferably of at least 9H.

|37| Use of the liquid composition according to any one of embodiments |1| to |32| for the production of an antistatic coating or an electromagnetic radiation shield or for the preparation of a hole-transport layer in an organic light emitting diode (OLED) or in an organic photovoltaic (OPV) element or in an organic photo detector (OPD).

A contribution towards achieving the above-mentioned objects is made by a liquid composition comprising
i) particles comprising a complex of a polythiophene and a polyanion; and
ii) a liquid phase, wherein the liquid phase comprises
iia) water and
iib) at least one organic solvent having
   a boiling point, determined at a pressure of 1013 mbar, in the range from 110 to 250° C., preferably in the range from 120 to 225° C. and most preferably in the range from 130 to 200° C.
   and
   a solubility in water, determined at 25° C., of at least 10 wt.-%, preferably at least 25 wt.-%, more preferably at least 50 wt.-% and most preferably at least 90 wt.-%;
wherein the liquid phase is an azeotrope or is capable of forming an azeotrope.

According to a preferred embodiment of the liquid composition according to the present invention the liquid composition is a dispersion in which particles i) are dispersed in the liquid phase ii).

### DETAILED DESCRIPTION OF THE DISCLOSURE

A liquid phase that is “capable of forming an azeotrope” in the sense of the present invention is a liquid phase that upon heating reaches a point at which the composition is an azeotrope. Preferably, it is the liquid phase that consists of water and high-boiling solvent that upon heating reaches a point at which the composition is an azeotrope.

A “solubility in water, determined at 25° C., of at least 10 wt.-%” is achieved if at a temperature of 25° C. at least 10 g of the organic solvent iib) can be dissolved in 100 g of water iia).

Surprisingly, it has been discovered that by adding high-boiling organic solvents to aqueous PEDOT/PSS-dispersions for the purpose of slowing down the drying speed of the aqueous dispersions, an undesired increase of the sheet resistance can be avoided if high-boiling organic solvents are used that are capable of forming an azeotrope with water.

The liquid composition according to the present invention comprises, as component i), particles comprising a polythiophene and a polyanion. In this context, polythiophenes having the general formula

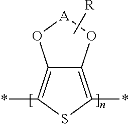

are particularly preferred, in which
A represents an optionally substituted C₁-C₅-alkylene radical, and
R represents a linear or branched, optionally substituted C₁-C₁₈-alkyl radical, an optionally substituted C₅-C₁₂-cycloalkyl radical, an optionally substituted C₆-C₁₄-aryl radical, an optionally substituted C₇-C₁₈-aralkyl radical, an optionally substituted C₁-C₄-hydroxyalkyl radical or a hydroxyl radical, wherein 0 to 8 radicals R can be bonded to A and, in the case of more than one radical, can be identical or different.

The polythiophenes preferably in each case carry H on the end groups.

In the context of the invention, C₁-C₅-alkylene radicals A are preferably methylene, ethylene, n-propylene, n-butylene or n-pentylene. C₁-C₁₈-alkyl R preferably represent linear or branched C₁-C₁₈-alkyl radicals, such as methyl, ethyl, n- or iso-propyl, n-, iso-, sec- or tert-butyl, n-pentyl, 1-methylbutyl, 2-methylbutyl, 3-methylbutyl, 1-ethylpropyl, 1,1-dimethylpropyl, 1,2-dimethylpropyl, 2,2-dime-thylpropyl, n-hexyl, n-heptyl, n-octyl, 2-ethylhexyl, n-nonyl, n-decyl, n-undecyl, n-dodecyl, n-tridecyl, n-tetradecyl, n-hexadecyl or n-octadecyl, C₅-C₁₂-cycloalkyl radicals R represent, for example, cyclopentyl, cyclohexyl, cycloheptyl, cyclooctyl, cyclononyl or cyclodecyl, C₅-C₁₄-aryl radicals R represent, for example, phenyl or naphthyl, and C₇-C₁₈-aralkyl radicals R represent, for example, benzyl, o-, m-, p-tolyl, 2,3-, 2,4-, 2,5-, 2,6-, 3,4-, 3,5-xylyl or mesityl. The preceding list serves to illustrate the invention by way of example and is not to be considered conclusive.

In the context of the invention, numerous organic groups are possible as optionally further substituents of the radicals A and/or of the radicals R, for example alkyl, cycloalkyl, aryl, aralkyl, alkoxy, halogen, ether, thioether, disulphide, sulphoxide, sulphone, sulphonate, amino, aldehyde, keto, carboxylic acid ester, carboxylic acid, carbonate, carboxylate, cyano, alkylsilane and alkoxysilane groups and carboxamide groups.

Polythiophenes in which A represents an optionally substituted C₂-C₃-alkylene radical are particularly preferred. Poly(3,4-ethylenedioxythiophene) is very particularly preferred as the polythiophene.

The polythiophenes can be neutral or cationic. In preferred embodiments they are cationic, with “cationic” relating only to the charges on the polythiophene main chain. The polythiophenes can carry positive and negative charges in the structural unit, depending on the substituent on the radicals R, the positive charges being on the polythiophene main chain and the negative charges optionally being on the radicals R substituted by sulphonate or carboxylate groups. In this context, the positive charges of the polythiophene main chain can be partly or completely satisfied by the anionic groups optionally present on the radicals R. Overall, in these cases the polythiophenes can be cationic, neutral or even anionic. Nevertheless, in the context of the invention they are all regarded as cationic polythiophenes, since the positive charges on the polythiophene main chain are the deciding factor. The positive charges are not shown in the formulae, since their precise number and position cannot be determined absolutely. However, the number of positive charges is at least 1 and at most n, where n is the total number of all recurring units (identical or different) within the polythiophene.

For compensation of the positive charge of the polythiophene, the particles i) comprising the polythiophene furthermore comprise a polyanion which is preferably based on polymers functionalized with acid groups. Anions of polymeric carboxylic acids, such as polyacrylic acids, polymethacrylic acid or polymaleic acids, or of polymeric sulphonic acids, such as polystyrenesulphonic acids and polyvinylsulphonic acids, are possible in particular as the polyanion. These polycarboxylic and sulphonic acids can also be copolymers of vinylcarboxylic and vinylsulphonic acids with other polymerizable monomers, such as acrylic acid esters and styrene. Polyanions which are furthermore possible are perfluorinated, colloid-forming polyanions, which are commercially obtainable, for example, under the name Nafion®. The molecular weight of the polymers which are functionalized with acid groups and supply the polyanions is preferably 1,000 to 2,000,000, particularly preferably 2,000 to 500,000. The polymers functionalized with acid groups or their alkali metal salts are commercially obtainable, e.g., polystyrenesulphonic acids and polyacrylic acids, or can be prepared by known processes (see, e.g., Houben Weyl, Methoden der organischen Chemie, vol. E 20 Makromolekulare Stoffe, part 2, p. 1141 et seq. (1987)). A particularly preferred polyanion is an anion of polystyrene sulfonic acid.

The particles i) comprise a complex of a polythiophene and a polyanion, particularly preferably a PEDOT/PSS-complex. Such complexes are obtainable by polymerizing the thiophene monomers, preferably 3,4-ethylenedioxythiophene, oxidatively in a preferably aqueous solution in the presence of the polyanions, preferably by oxidatively polymerizing 3,4-ethylene-dioxythiophene in the presence of an anion of polystyrenesulphonic acid.

The weight average diameter (d₅₀) of the particles i) comprising the complex of a polythiophene and a polyanion is typically in the range from 10 nm to 2,000 nm, more preferably in the range from 20 nm to 500 nm, and most preferably in the range from 25 nm to 50 nm. The d₅₀-value of the diameter distribution states that 50% of the total weight of all the particles i) can be assigned to those particles which have a diameter of less than or equal to the d₅₀ value (the d₅₀ value thus represents the weight average particle diameter). As in the case of PEDOT/PSS-particles dispersed in an aqueous solution, the particles are usually present in the form of swollen gel particles and the above-mentioned particle sizes refer to the particles size of the swollen gel particles and are determined using an ultracentrifuge measurement.

According to a preferred embodiment of the liquid composition according to the present invention the liquid composition comprises the complex i) of a polythiophene and a polyanion, preferably PEDOT/PSS, in an amount of 0.001 to 2.5 wt.-%, more preferably 0.005 to 1.0 wt.-% and most preferably 0.01 to 0.5 wt.-%, in each case based on the total weight of the liquid composition.

The liquid composition according to the present invention comprises, as component ii), a liquid phase, wherein the liquid phase comprises water iia) and at least one organic solvent iib) having a boiling point, determined at a pressure of 1013 mbar, in the range from 110 to 250° C., preferably in the range from 120 to 225° C. and most preferably in the range from 130 to 200° C., and having a solubility in water, determined at 25° C., of at least 10 wt.-%, preferably at least 25 wt.-%, more preferably at least 50 wt.-% and most preferably at least 90 wt.-%, wherein the liquid phase is an azeotrope or is capable of forming an azeotrope.

According to the present invention it is furthermore preferred that the organic solvent iib) is an alcohol, an ether, preferably diglyme, or a mixture therefore, more preferably an alcohol selected from the group consisting of ethyl glycol (i.e., 2-ethoxyethanol), butyl glycol (i.e., 2-butoxyethanol), diacetone alcohol (i.e., 4-hy-droxy-4-methylpentan-2-one) or a mixture of these alcohols and most preferably diacetone alcohol.

According to a preferred embodiment of the liquid composition according to the present invention the liquid composition further comprises
iii) at least one additive selected from the group consisting of an UV-stabilizer, a surface-active substance, a low-boiling solvent, a pH-regulator, a crosslinker, a rheology modifier or a combination of at least two of these additives.

The UV-stabilizer that can be present as at least one further additive iii) is preferably gallic acid, a derivative of gallic acid or a mixture thereof. Particularly preferred derivatives of gallic acid are esters of gallic acid and sugar which are often called tannin or gallotannins (cf. Römpp Chemie, 10th edition, page 4391 (1999)). Further preferred derivatives of gallic acid are alkyl esters, alkenyl esters, cycloalkyl esters, cycloalkenyl esters and aryl esters of gallic acid, preferably those having 1 to 15 C-atoms, preferably 1 to 6 C-atoms atoms in the alkyl group, the alkenyl group, the cycloalkyl group, the cycloalkenyl group or the aryl group of the ester. Most preferred derivatives of gallic acid are gallotannines, such as tannic acid, or alkylesters of gallic acid such as methyl gallate, ethyl gallate, propyl gallate or a mixture of at least two of these esters.

According to a preferred embodiment of the liquid composition according to the present invention the liquid composition comprises gallic acid, a derivative of gallic acid or a mixture thereof, preferably a gallotannine, more preferably tannic acid, in an amount of 0.0001 to 5 wt.-%, more preferably 0.001 to 2.5 wt.-% and most preferably 0.01 to 1 wt.-%, in each case based on the total weight of the liquid composition. If the liquid composition comprises a mixture of gallic acid and a derivative thereof or a mixture of at least two derivatives of gallic acid as component iii), the above amounts represent the total amount of these components.

The crosslinker that can be present as at least one further additive iii) is preferably a tetraalkyl orthosilicate. Preferred tetraalkyl orthosiliscates are selected from the group consisting of tetramethyl orthosilicate, tetraethyl orthosilicate, tetrapropyl orthosilicate, tetrabutyl orthosilicate, tetrapentyl orthosilicate, an at least partially hydrolysed product of these orthosiliscates and a mixture of at least two of these orthosiliscates, wherein the use of tetraethyl orthosilicate (TEOS) is particularly preferred.

According to a preferred embodiment of the liquid composition according to the present invention the liquid composition comprises a tetraalkyl orthosilicate, preferably TEOS, in an amount of 0.01 to 15 wt.-%, more preferably 0.1 to 10 wt.-% and most preferably 1 to 5 wt.-%, in each case based on the total weight of the liquid composition. If the liquid composition comprises a mixture of two or more tetraalkoxysilanes as component iii), the above amounts represent the total amount of these components.

A “low-boiling solvent” in the sense of the present invention that can be present as at least one further additive iii) is a solvent having a boiling point, determined at a pressure of 1013 mbar, of less than 100° C., preferably of less than 90° C. and more preferably of less than 80° C. A preferred low-boiling solvent is ethanol. In this context it is also preferred that the liquid composition comprises the low-boiling solvent, preferably ethanol, in an amount of 10 to 90 wt.-%, more preferably 20 to 85 wt.-% and most preferably 30 to 80 wt.-%, in each case based on the total weight of the liquid composition.

In this context it is also preferred that the volume ratio water:ethanol in the liquid composition according to the present invention is in the range from 1:1 to 1:25, preferably in the range from 1:2 to 1:20 and more preferably in the range from 1:3 to 1:10. The volumes are determined for the individual components before mixing.

Suitable surface-active substances that can be used as at least one further additive iii) are, for example, anionic surfactants, such as, e.g., alkylbenzenesulphonic acids and salts, paraffin sulphonates, alcohol sulphonates, ether sulphonates, sulphosuccinates, phosphate esters, alkyl ether carboxylic acids or carboxylates, cationic surfactants, such as, e.g., quaternary alkylammonium salts, nonionic surfactants, such as, e.g., linear alcohol ethoxylates, oxo alcohol ethoxylates, alkylphenol ethoxylates or alkyl polyglucosides, in particular surfactants that are commercially available under the trademarks Dynol® and Zonyl®.

The viscosity of the liquid composition according to the present invention is preferably between 10 and 100 mPa×s (measured with a rheometer at 20° C. and a shear rate of 100 s⁻¹). More preferably, the viscosity is between 1 and 10 mPa×s, particularly preferably between 2 and 5 mPa×s. The adjustment of the viscosity can, for example, be accomplished by adding appropriate rheology modifiers as a further additive iii).

According to a preferred embodiment of the liquid composition according to the present invention the pH of the liquid composition is not less than 2.5, more preferably the pH is in the range from 2.5 to 6, even more preferably in the range from 2.5 to 5 and most preferably in the range from 2.5 to 4, wherein the pH is determined at a temperature of 25° C. The pH can be adjusted by adding appropriate pH-regulators such as organic or inorganic acids as a further additive iii) to the liquid composition. Suitable acids are inorganic acids such as sulfuric acid, hydrochloric acid, nitric acid, phosphoric acid, silicic acid or a mixture of at least two of these inorganic acids, or organic acids such as acetic acid, formic acid, benzoic acid, p-toluensulfonic acid, PSS or a mixture of at least two of these organic acids, or a mixture of at least one of these inorganic acids and at least one of these organic acids.

The liquid composition according to the present invention may further comprise
iv) at least one further polymer being different from the polythiophene and the polyanion,
   wherein this at least one further polymer iv) preferably serves as a binder. Suitable binders are selected from the group consisting of polyvinyl alcohols, polyvinylpyrrolidones, polyvinyl chlorides, polyvinyl acetates, polyvinyl butyrates, polyacrylic esters, polyacrylamides, polymethacrylic esters, polymethacrylamides, polyacrylonitriles, styrene/acrylic ester, vinyl acetate/acrylic ester, ethylene/vinyl acetate copolymers, polybutadienes, polyisoprenes, polystyrenes, polyethers, polyesters, sulfonated polyesters, polycarbonates, polyurethanes, polyamides, polyimides, polysulfones, melamine-formaldehyde resins, epoxy resins, silicone resins, silane resins, celluloses or a mixture of at least two of these binders. Further useful polymeric binders are preferably also those which are obtained by adding crosslinkers, for example melamine compounds, capped isocyanates or functional silanes, for example 3-glycidoxypropyltrialkoxysilane, tetraethyl orthosilicate and tetraethyl orthosilicate hydrolyzate, to crosslinkable polymers, for example polyurethanes, polyacrylates or polyolefins, and subsequently crosslinking. Water-soluble binders, such as sulfonated polyesters, are particularly preferred.

According to a preferred embodiment of the liquid composition according to the present invention the liquid composition comprises water iia) in an amount in the range from 10 to 98 wt.-%, preferably in the range from 20 to 97 wt.-%, more preferably in the range from 30 to 96 wt.-% and even more preferably in the range from 40 to 95 wt.-%, in each case based on the total weight of the liquid composition.

According to a further preferred embodiment of the liquid composition according to the present invention the liquid composition comprises the at least one organic solvent iib), preferably ethyl glycol, butyl glycol, diacetone alcohol or a mixture thereof, more preferably diacetone alcohol, in an amount of less than 10 wt.-%, preferably less than 8.5 wt.-% and more preferably less than 7 wt.-%, in each case based on the total weight of the liquid composition. In the case of two or more organic solvents iib), these amounts define the total amount of organic solvents iib).

A dried layer prepared with the liquid composition according to the present invention preferably has a sheet resistance of at least 1×10⁶ Ω/sq, preferably of at least 5×10⁶ Ω/sq and more preferably of at least 1×10⁷ Ω/sq.

A dried layer prepared with the liquid composition according to the present invention preferably has an internal transmission of at least 98% preferably of at least 98.5%, more preferably of at least 99% and most preferably of at least 99.5%

A dried layer prepared with the liquid composition according to the present invention preferably has a pencil hardness of at least 6H, preferably of at least 7H, more preferably of at least 8H and most preferably of at least 9H.

A contribution towards achieving the above-mentioned objects is also made by a process for the production of a layered body, comprising the process steps:
A) the provision of a substrate;
B) the application of the liquid composition according to the present invention onto this substrate; and
C) the at least partial removal of the liquid phase ii) from the liquid composition to obtain a layered body comprising an electrically conductive layer coated onto the substrate.

In process step A), a substrate is first provided, wherein the nature of the substrate depends on the intended purpose for which the composition according to the present invention is employed. Suitable substrates include films, particularly preferably polymer films, very particularly preferably polymer films of thermoplastic polymers, or glass plates.

In process step B), the liquid composition according to the present invention is then applied onto the substrate, it being possible for this application to be carried out by known processes, e.g., by spin coating, impregnation, pouring, dripping on, spraying, misting, knife coating, slot die coating, brushing or printing, for example, by ink-jet, screen, gravure, offset or tampon printing, preferably by slot die coating, spraying or ink-jet printing, in a wet film thickness of from, for example, 0.5 μm to 250 μm, preferably in a wet film thickness of from 2 μm to 50 μm.

In process step C), at least a part of the liquid phase ii) is then removed from the liquid composition to obtain a layered body comprising an electrically conductive layer coated onto the substrate, this removal preferably being carried out by drying at a temperature in a range of from 20° C. to 200° C. the substrate coated with the composition.

A contribution towards achieving the above-mentioned objects is also made by a layered body which is obtainable by the process described above. In this context it is particularly preferred that the conductive layer of the layered body is characterized by at least one of the following properties (α1) to (α3), preferably by all of these properties:
(α1) a sheet resistance of at least 1×10⁶ Ω/sq, preferably of at least 5×10⁶ Ω/sq and more preferably of at least 1×10⁷ Ω/sq;
(α2) an internal transmission of at least 98%, preferably at least 98.5%, more preferably at least 99% and most preferably at least 99.5%; and
(α3) a pencil hardness of at least 6H, preferably at least 7H, more preferably at least 8H and most preferably at least 9H.

A contribution towards achieving the above-mentioned objects is also made by the use of the liquid composition according to the present invention or of the liquid composition obtainable by the process according to the present invention for the production of a layered body comprising a substrate and an electrically conductive layer coated onto the substrate.

The layered bodies that can be prepared with the liquid composition according to the present invention are outstandingly suitable for use as electronic components, in particular as conductive or antistatic components, as transparent heating or as electrodes. They can advantageously be transparent.

These layered bodies can be employed as electronic components, for example also on films, packaging of electronic components, for finishing films of plastics and for coating screens. They can furthermore be used as transparent electrodes, e.g., in displays, for example as a substitute for indium-tin oxide electrodes, or as electrical conductors in polymeric electronics. Further possible uses are sensors, batteries, solar cells, electrochromic windows (smart windows) and displays and corrosion protection.

In view of the low conductivity, the high UV-stability and the high scratch resistance of the coatings obtained with the liquid composition according to the present invention these liquid compositions are particularly useful for the production of an antistatic coating or an electromagnetic radiation shield. They are furthermore particularly useful for the preparation of a hole-transport layer in an organic light emitting diode (OLED) or in an organic photovoltaic (OPV) element or in an organic photo detector (OPD).

The invention is now explained in more detail with the aid of non-limiting examples. The following examples are included to more clearly demonstrate the overall nature of the disclosure.

### Test Methods

### Determination of the Sheet Resistance

The sheet resistance was measured with a High Resistivity Meter Model Hiresta—UX (Model MCP-HT 800) equipped with a Ring-Probe URS RMH214. The measurement was conducted at 100V.

### Pencil Hardness

Pencil hardness of a coating is conducted by sliding various pencils of different hardness across a coating deposited on a glass plate according to ISO 15184. The possible impact of the pencil trace on the coating is evaluated by eye.

### Transmission

The internal transmission of the coated substrates is determined on a 2-channel spectrometer (Lambda900, PerkinElmer). In order to rule out interferences of the scattered light, the sample is measured in a photometer sphere (Ulbricht sphere), as a result of which scattered light and transmitted light are detected by the photodetector. The transmission is thus understood as meaning the absorption of the coating and of the substrate. The transmission of the pure substrate is first measured. Melinex 506 films having a thickness of 175 μm are used as the substrate. Thereafter, the coated substrate is measured. The transmission spectra are recorded in the range of visible light, i.e., from 320 nm to 780 nm with a step width of 5 nm.

The standard color value Y of the sample is calculated from the spectra in accordance with DIN 5033, taking as the basis a 10° observer angle and light type D65. The internal transmission is calculated from the ratio of the standard color values of the substrate with coating (Y) to that without coating (Y₀). The internal transmission corresponds to Y/Y₀×100 in percent. For simplicity, only transmission is referred to the in the following.

### EXAMPLES

### Example 1

Clevios P VP CH 8000 (Heraeus) (PEDOT/PSS-weight ratio 1:20; solid content: 2.8 wt.-%) was mixed with different amounts of different solvents as indicated in Table 1 (all fully soluble in water). For example, to obtain sample 2, 95 g Clevios P VP CH 8000 were mixed with 5 g butyl glycol and stirred for 10 minutes. The dispersions were tested with respect to nozzle clogging. Samples were spin-coated onto glass substrates and dried at 200° C. for 15 minutes. The sheet resistance was determined. Table 1 summarizes the results. Inventive samples 2, 3, 4, 5 and 6 are compared to reference samples 7 and 8.

TABLE 1

| | | con- | boiling | | | |
|---|---|---|---|---|---|---|
| | | cen- | point | sheet | | |
| sam- | added | tration | solvent | resistance | nozzle | film |
| ple | solvent | [%] | [° C.] | [Ohm/sq] | clogging | quality |
| 1 | none | | | 1.5 × 10⁹ | yes | good |
| 2 | butyl glycol | 5 | 171 | 5.7 × 10⁹ | no | good |
| 3 | diacetone | 1 | 166 | 1.8 × 10⁹ | no | good |
| | alcohol | | | | | |
| 4 | diacetone | 2.5 | 166 | 3.6 × 10⁹ | no | good |
| | alcohol | | | | | |
| 5 | diacetone | 5 | 166 | 2.5 × 10⁹ | no | good |
| | alcohol | | | | | |
| 6 | diacetone | 10 | 166 | 3.9 × 10⁶ | no | good |
| | alcohol | | | | | |
| 7 | DMSO | 5 | 189 | 4.6 × 10⁴ | no | good |
| 8 | ethylene | 5 | 199 | 4.2 × 10⁵ | no | good |
| | glycol | | | | | |

Only the high-boiling solvents that form azeotropes with water do not change resistivity of CH 8000-films significantly, whereas DMSO or ethylene glycol do.

### Example 2

0.1 g tannic acid were dissolved in 84 g of ethanol. 12.6 g Clevios P (Heraeus) were placed in a 250 ml glass beaker. The solution of tannic acid in ethanol was added to the Clevios P dispersion under stirring. 3.1 g tetraethyl orthosilicate were added to the mixture. The pH was adjusted to 3.3. Different amounts of additional solvents (as indicated in Table 2) were added to the dispersion. The mixture was stirred for 30 minutes at room temperature.

A film with a wet film thickness of 12 μm was deposited on alkali-free glass using a wire bar and subsequently dried at 120° C. for 20 minutes. Table 2 shows the results. Inventive samples 10 and 11 are compared to reference samples 9 and 12 to 16.

TABLE 2

| | added | | | | | |
|---|---|---|---|---|---|---|
| | solvent | concen- | sheet | | pencil | |
| sam- | (solubility | tration | resistance | nozzle | hard- | film |
| ple | in water) | [%] | [Ohm/sq] | clogging | ness | quality |
| 9 | none | | 1 × 10⁸ | yes | 8H | good |
| 10 | diacetone | 7 | 4 × 10⁷ | no | 8H | good |
| | alcohol | | | | | |
| | (fully) | | | | | |
| 11 | diacetone | 11 | 2 × 10⁷ | no | 8H | de- |
| | alcohol | | | | | wetting |
| | (fully) | | | | | |
| 12 | 3-Methyl-1- | 5 | 1 × 10⁶ | no | 7H | turbid |
| | butanol | | | | | film |
| | (3%) | | | | | |
| 13 | PGMEA | 5 | 1 × 10⁸ | no | 3H | turbid |
| | (20%) | | | | | film |
| 14 | 1-butanol | 5 | 6 × 10⁶ | no | 5H | de- |
| | (8%) | | | | | wetting |
| 15 | dipropylene | 10 | 1 × 10⁹ | no | 8H | turbid |
| | glycol | | | | | film |
| | n-propyl | | | | | |
| | ether (15%) | | | | | |
| 16 | propylene | 3 | 1 × 10⁸ | no | 1H | turbid |
| | glycol | | | | | film |
| | diacetate | | | | | |
| | (7%) | | | | | |

### Example 3

Clevios P VP CH 8000 was concentrated to 3.24% solids. Various high-boiling solvents were added in different amounts to this “Clevios CH8000 concentrated” (PEDOT/PSS-weight ratio 1:20; solid content: 3.24 wt.-%). Samples were spin-coated onto glass substrates and dried at 200° C. for 15 minutes. The sheet resistance was determined as shown in Table 3. The layer thickness for the samples was 200 nm.

TABLE 3

| | | CH 8000 |
|---|---|---|
| | | concentrated |
| | | sheet |
| | | resistance |
| Sample | added solvent | [Ω/sq] |
| 17 | None | 7.5 × 10⁹ |
| 18 | butyl glycol (1 wt.-%) | 9 × 10⁹ |
| 19 | butyl glycol (2.5 wt.-%) | 1.3 × 10¹⁰ |
| 20 | butyl glycol (5 wt.-%) | 1.8 × 10¹⁰ |
| 21 | butyl glycol (10 wt.-%) | 4 × 10⁸ |
| 22 | ethyl glycol (1 wt.-%) | 9 × 10⁹ |
| 23 | ethyl glycol (2.5 wt.-%) | 1 × 10¹⁰ |
| 24 | ethyl glycol (5 wt.-%) | 1.8 × 10¹⁰ |

Inventive samples 18 to 24 are compared to reference sample 17.

Although illustrated and described above with reference to certain specific embodiments and examples, the present disclosure is nevertheless not intended to be limited to the details shown. Rather, various modifications may be made in the details within the scope and range of equivalents of the claims and without departing from the spirit of the disclosure.

1. A liquid composition comprising:
i) particles comprising a complex of a polythiophene and a polyanion; and
ii) a liquid phase comprising
water and
at least one organic solvent having
a boiling point, determined at a pressure of 1013 mbar, in the range from 110 to 250° C. and
a solubility in water, determined at 25° C., of at least 10 wt.-%,
wherein the liquid phase is an azeotrope or is capable of forming an azeotrope.

2. The liquid composition according to claim 1, wherein the polythiophene is poly(3,4-ethylenedioxythiophene) and wherein the polyanion is an anion of polystyrene sulfonic acid.

3. The liquid composition according to claim 1, wherein the at least one organic solvent is an alcohol, an ether or a mixture thereof.

4. The liquid composition according to claim 3, wherein the alcohol is selected from the group consisting of ethyl glycol, butyl glycol, diacetone alcohol, diethylene glycol dimethyl ether or a mixture thereof.

5. The liquid composition according to claim 4, wherein the alcohol is diacetone alcohol.

6. The liquid composition according to claim 1, further comprising ethanol.

7. The liquid composition according to claim 1, further comprising tetraethyl orthosilicate (TEOS).

8. The liquid composition according to claim 1, wherein the complex of a polythiophene and a polyanion is present in an amount in the range from 0.001 to 2.5 wt.-%, based on the total weight of the liquid composition.

9. The liquid composition according to claim 1, wherein the water is present in an amount in the range from 10 to 98 wt.-%, based on the total weight of the liquid composition.

10. The liquid composition according to claim 1, wherein the at least one organic solvent is present in an amount of less than 10 wt.-%, based on the total weight of the liquid composition.

11. The liquid composition according to claim 1, wherein a dried layer prepared with the liquid composition has a sheet resistance of at least 1×10⁶ Ω/sq.

12. A process for the preparation of a layered body, comprising the process steps:
A) providing a substrate;
B) applying the liquid composition according to claim 1 onto the substrate; and
C) at least partially removing the liquid phase from the liquid composition to obtain a layered body comprising an electrically conductive layer coated onto the substrate.

13. The process according to claim 12, wherein the step of applying the liquid composition in process step B) is performed by slot die coating, spraying or ink-jet printing.

14. A layered body obtained by the process according to claim 12.

15. Use of the liquid composition according to claim 1 for the formation of an antistatic coating or an electromagnetic radiation shield or for the preparation of a hole-transport layer in an organic light emitting diode (OLED) or in an organic photovoltaic (OPV) element or an organic photo detector (OPD).

16. A layered body, obtained by the process according to claim 13.

17. The liquid composition according to claim 1, wherein (a) the polythiophene is poly(3,4-ethylenedioxythiophene), (b) the polyanion is an anion of polystyrene sulfonic acid, and (c) the at least one organic solvent is an alcohol selected from the group consisting of ethyl glycol, butyl glycol, diacetone alcohol, diethylene glycol dimethyl ether, or a mixture thereof; an ether; or a mixture thereof.

18. The liquid composition according to claim 1 further comprising ethanol and tetraethyl orthosilicate (TEOS).

19. The liquid composition according to claim 1 wherein the complex of a polythiophene and a polyanion is present in an amount in the range from 0.001 to 2.5 wt.-% based on the total weight of the liquid composition, the water is present in an amount in the range from 10 to 98 wt.-% based on the total weight of the liquid composition, and the at least one organic solvent is present in an amount of less than 10 wt.-% based on the total weight of the liquid composition.

20. The liquid composition according to claim 1 further comprising ethanol and tetraethyl orthosilicate (TEOS) and wherein (a) the polythiophene is poly(3,4-ethylenedioxythiophene), (b) the polyanion is an anion of polystyrene sulfonic acid, (c) the complex of poly(3,4-ethylenedioxythiophene) and an anion of polystyrene sulfonic acid is present in an amount in the range from 0.001 to 2.5 wt.-% based on the total weight of the liquid composition, (d) the at least one organic solvent is an alcohol selected from the group consisting of ethyl glycol, butyl glycol, diacetone alcohol, diethylene glycol dimethyl ether, or a mixture thereof; an ether; or a mixture thereof and the at least one organic solvent is present in an amount of less than 10 wt.-% based on the total weight of the liquid composition, and (e) the water is present in an amount in the range from 10 to 98 wt.-% based on the total weight of the liquid composition.
